(19) United States
(12) Patent Application Publication
(10) Pub. No.: US 2013/0234605 A1
(43) Pub. Date: Sep. 12, 2013

(54) Hybrid Outdoor Streetlamp Assembly

(71) Applicant: Howard Burrows, Mays Landing, NJ (US)

(72) Inventor: Howard Burrows, Mays Landing, NJ (US)

(73) Assignee: Pollution Solutions Renewable Energy LLC, Mays Landing, NJ (US)

(21) Appl. No.: 13/413,513

(22) Filed: Mar. 6, 2012

(51) Int. Cl. H05B 37/02; F21L 4/02; F21L 4/08

(52) U.S. Cl. 315/158; 362/183

(57) ABSTRACT

An outdoor light assembly is structured as a generally vertically oriented pole and includes a lamp atop the pole, a solar panel array atop the lamp, a wind turbine attached to a generator, and a battery. The wind turbine drives the generator and the generator and the solar panel array both output electrical energy stored to the battery. The battery delivers the stored energy to the lamp. The wind turbine is housed within a cage defined in the pole at a midpoint in a vertical extent of the pole and generally coaxial with the pole. The solar panel array atop the lamp is substantially hidden from below by the pole and the lamp.

### BACKGROUND OF THE INVENTION

1. Field of the Invention

The present disclosure relates to a hybrid outdoor lamp assembly for providing overhead light at night or the like, where a lamp of the assembly is powered by both a solar panel array and a wind turbine of the assembly. More particularly, the present disclosure relates to such a lamp assembly where the wind turbine is a vertical-axis wind turbine that is mounted at a midpoint within a vertical pole of the assembly, the lamp is an LED lamp mounted above the turbine, and the solar panel array is mounted above the lamp.

2. Description of Related Art

As is known, an outdoor lamp is typically provided to generate and emit light during nighttime or other times when ambient outdoor lighting is lacking. Such an outdoor lamp often is often mounted atop a pole or the like, and is provided in most any area where such emitted light may be needed, including on a street, in a park, in a parking lot, on a walking path, in a yard, at a storefront, at a building entry, etc. In many cases such an outdoor lamp is powered by electricity or the like as is generated, transmitted, and/or distributed by a power supplier. As should be appreciated, then, wiring and/or other distribution structures and materials must be provided to supply the powering electricity from an available source to the outdoor lamp.

At times, however, such an available source for the powering electricity may not be readily available and/or such wiring and/or other distribution structures and materials may not be readily available. Correspondingly, providing such available source and/or such wiring and/or other distribution structures and materials may be problematic, for any of a multitude of reasons. As but one example, it may be that the outdoor lamp is required in the middle of a field or at a beach, but that the available source of powering electricity is relatively far away, or that stringing wiring to the outdoor lamp is prohibited due to safety concerns, among other things.

In a similar manner, it may be that, regardless of whether an available source for the powering electricity is readily available and/or such wiring and/or other distribution structures and materials is readily available, a desire is expressed to power the outdoor lamp without the use of such available source of powering electricity. For example, it may be that the cost of such powering electricity is deemed prohibitively expensive, or that the cost of providing such wiring and/or other distribution structures and materials is deemed prohibitively expensive. Similarly, it may be that a desire is expressed to power the outdoor lamp by so-called renewable energy sources, such as from wind power, solar power, and/or the like, in which case the wiring and/or other distribution structures and materials would not be required.

In any such instance, it is known to operate an outdoor lamp by the aforementioned wind power and/or solar power or a combination thereof. In particular, it is known to include the outdoor lamp within a hybrid outdoor lamp assembly that also includes a solar panel array, a wind turbine and generator, and related equipment that stores power generated by the solar panel array and the wind turbine in a battery and that delivers the stored power from the battery to the outdoor lamp as needed.

Typically, although by no means necessarily, such a hybrid outdoor lamp assembly is generally formed to appear as and is perceived by the general public as a generally vertical pole, where at least the outdoor lamp is mounted near the top of the pole. Thus, the light emitted by the outdoor lamp spreads to a broader ground area. As should be appreciated, such a pole should have a relatively small overall lateral extent a relatively large height, and therefore is perceived as generally unobtrusive, at least aesthetically.

In the prior art, many hybrid outdoor lamp assembly manufacturers employ relatively large solar panel arrays that are attached laterally to the pole and thus appear to ‘hang off’ the side of the pole. Significantly, such relatively large solar panel arrays hanging off the side of the pole impart a relatively large overall lateral extent to the pole, and thus are perceived as being obtrusive and unaesthetic. Moreover, from an architectural point of view, such relatively large solar panels look wholly out of place and the overall visual appearance imparted thereby has been known to elicit disgust and even revulsion.

In the prior art, many hybrid outdoor lamp assembly manufacturers employ horizontal-axis wind turbines. As should be understood, such turbines rotate on an axis that is generally horizontal, and thus have relatively long windmill-type turbine blades, perhaps on the order of four or five feet, that extend generally radially from such horizontal axis. Significantly, such relatively long turbine blades also impart a relatively large overall lateral extent to the pole, and thus are also perceived as being obtrusive and unaesthetic.

In the prior art, other hybrid outdoor lamp assembly manufacturers employ vertical-axis wind turbines. As should be understood, such turbines rotate on an axis that is generally vertical, and thus have blades arranged to extend axially along such vertical axis. While such turbines are typically generally coaxial with the overall vertical extent of the pole, such manufacturers have not taken care to reign in the overall lateral extent of such vertical-axis wind turbines, and such overall lateral extent again is perceived as being obtrusive and unaesthetic.

In the prior art, when vertical-axis wind turbines are employed, such vertical turbines are mounted on top of the poles. Thus, the turbines are effectively supported only at the bottom thereof and are particularly vulnerable to wind shear force. In particular, such shear force acts laterally to the axis of the turbine and if strong enough can disengage the turbine from the pole. Moreover, such shear force has been found to exert excessive axial bending force on the axis of the generator, particularly if directly coaxially connected to the axis of the generator, thus excessively wearing and even destroying the bushing or other mount within which the axis of the generator is secured.

A need exists then, for a hybrid outdoor lamp assembly with a solar panel array that is attached atop the pole so as to be perceived as being unobtrusive and aesthetic. Also, a need exists for such a hybrid outdoor lamp assembly that employs a vertical-axis wind turbines with a relatively small overall lateral extent so as to also be perceived as being unobtrusive and aesthetic. Further, a need exists for such a hybrid outdoor lamp assembly with a vertical-axis wind turbine that is mounted at a midpoint of the pole such that the turbine is effectively supported both at the bottom and top thereof and is not vulnerable to wind shear force. Finally, a need exists for such a hybrid outdoor lamp assembly that has improved overall aesthetics so that the assembly blends harmoniously into the surrounding landscape.

### BRIEF SUMMARY OF THE INVENTION

The aforementioned need is satisfied by an outdoor light assembly structured as a generally vertically oriented pole, where the assembly includes a lamp atop the pole, a wind turbine attached to a generator, and a battery. The wind turbine drives the generator and the generator outputs electrical energy upon being so driven, and the battery stores the electrical energy outputted by the generator and delivers the stored energy to the lamp. The wind turbine is housed within a cage defined in the pole at a midpoint in a vertical extent of the pole and generally coaxial with the pole. The midpoint is defined by structures of the pole both above and below such midpoint, and the turbine is supported within the cage in the pole at both upper and lower regions thereof by being coupled to the structure of the pole both above and below.

The assembly may also include a solar panel array atop the lamp for outputting electrical energy, where the battery also stores the electrical energy outputted by the solar panel array and delivers such stored energy to the lamp. The solar panel array atop the lamp is substantially hidden from below by the pole and the lamp.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a perspective view of a generally hybrid outdoor lamp assembly in accordance with an embodiment of the present invention, where the assembly includes a solar panel array on top, a lamp underneath the solar panel assembly, and a vertical-axis wind turbine and generator underneath the lamp;

FIG. 2 is a top-down view of the assembly of FIG. 1 in accordance with an embodiment of the present invention, and shows the solar panel array atop the lamp;

FIG. 3a is a partially cut-away and exploded view of the turbine and generator and related components of the assembly of FIG. 1 in accordance with an embodiment of the present invention, where the blades of the turbine have been omitted for the sake of clarity;

FIG. 3b is a partially cut-away view of the turbine and generator and related components of the assembly of FIG. 1 as positioned within the pole in accordance with an embodiment of the present invention, where the blades and supports of the turbine have been omitted for the sake of clarity;

FIG. 4 is a top-down view of a representative one of the blade supports of the turbine of FIGS. 3a and 3b in accordance with an embodiment of the present invention;

FIG. 5 is a plan view of a representative one of the blades of the turbine of FIGS. 3a and 3b in accordance with an embodiment of the present invention; and

FIG. 6 is a schematic view of the electrical elements of the assembly of FIG. 1 as interconnected in accordance with an embodiment of the present invention.

### DETAILED DESCRIPTION OF THE INVENTION

Certain terminology may be used in the following description for convenience only and is not considered to be limiting. For example, the words “left”, “right”, “upper”, “lower”, “top”, “bottom”, “front”, and “back” designate directions in the drawings to which reference is made. Likewise, the words “inwardly” and “outwardly” are directions toward and away from, respectively, the geometric center of the referenced object. The terminology includes the words above specifically mentioned, derivatives thereof, and words of similar import.

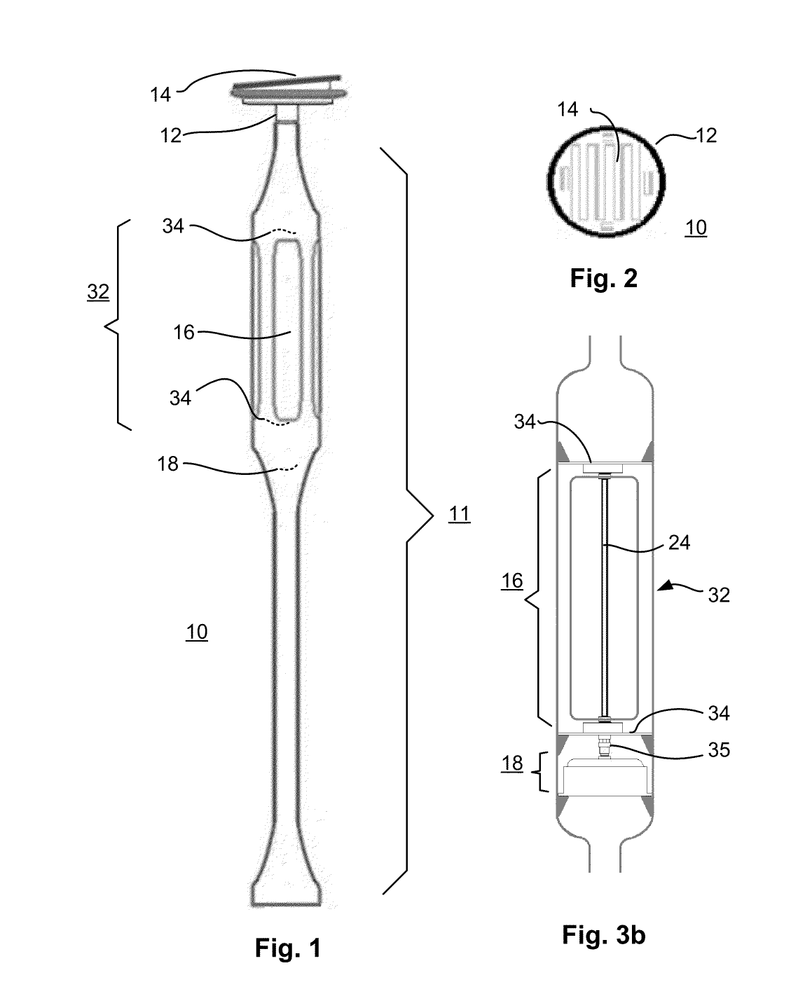

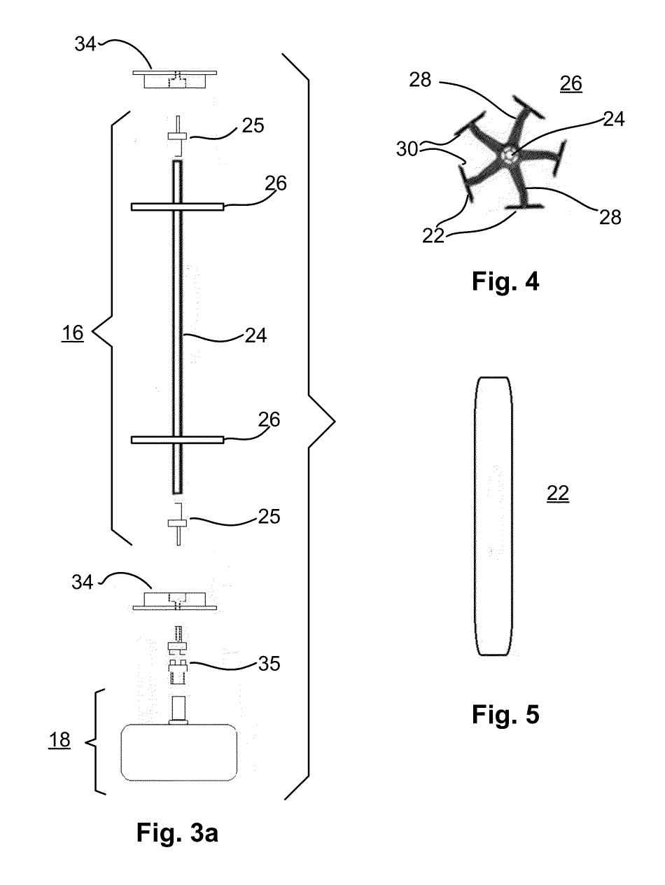

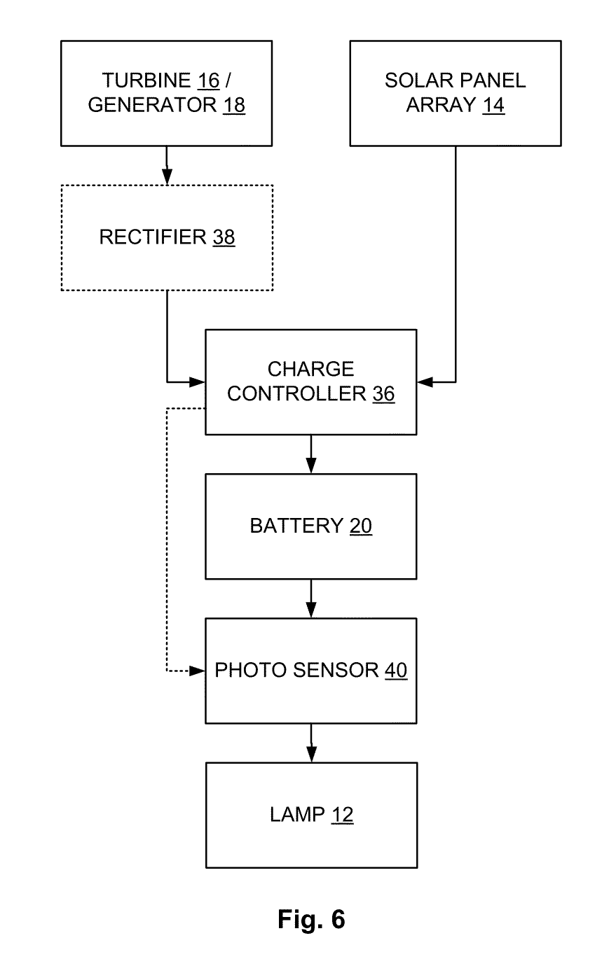

Turning now to FIGS. 1 and 2, it is seen that the present disclosure sets forth a hybrid outdoor light assembly 10 in accordance with various embodiments of the present innovation, where the assembly 10 is generally structured as a generally vertically oriented pole 11 or the like which includes a lamp 12, a solar panel array 14 (FIG. 2) which acts as a first source of energy, a wind turbine 16 attached to a generator 18 (FIGS. 3-5) which acts as a second source of energy, and a battery 20 (FIG. 6) which stores the energy sourced by the solar panel array 14 and generator 18 and which delivers the stored energy to the lamp 12 at appropriate times. Generally, the hybrid outdoor lamp assembly 10 as developed resolves design flaws inherent in prior art assemblies by integrating the lamp 12, solar panel array 14, turbine 16, generator 18, and battery 20 into the aforementioned pole 11 in a manner that is technically sound and aesthetically pleasing.

As shown in FIG. 1, the pole 11 of the assembly 10 houses and/or supports the lamp 12, solar panel array 14, turbine 16, generator 18, and battery 20. Such pole 11 may be formed as a unitary body, perhaps with appropriate accessing panels as needed, or may be formed as multiple individual parts that are combined in an appropriate manner, all without departing from the spirit and scope of the present innovation. Inasmuch as the pole 11 is intended to be both functional and decorative, such pole 11 may be imparted with any appropriated decorative design, such as for example fluting, florets, carved designs, etc. Likewise, the pole 11 may be circular or rectangular in cross-section. As presently envisioned, the pole 11 may be constructed from a light-weight durable material such as a cast aluminum or steel or the like, although other materials including plastic, elastomeric, and polymeric materials may also be employed.

In order to be aesthetically pleasing, it is expected that the pole 11 should be relatively thin in general lateral extent (i.e., left-to-right in FIG. 1) and relatively tall in vertical extent (i.e., top-to-bottom in FIG. 1). That said, the pole 11 may have any appropriate dimensions as may be required based on design and use considerations, among other things. Thus, it is expected that the pole 11 and the assembly 10 overall may be anywhere from 6 to 40 feet tall or more. Presumptively, the pole 11 is to be anchored with respect to the ground in a manner so that the pole 11 and assembly 10 are not blown over by any wind that can reasonably be expected. Thus, the pole 11 may be planted in the ground or may be anchored to a base that has been planted in the ground, in a manner that should be understood by the relevant public and therefore need not be set forth herein in any detail. Generally, the pole 11 may have any appropriate design without departing from the spirit and scope of the present innovation.

The lamp 12 is as was set forth above powered from the battery 20 and therefore should be a relatively low-power lamp that can emit a sufficient amount of light based on the area to be lit, the capacity of the battery 20, the amount of time that the lamp 12 is expected to be on, and the amount of light required from the lamp 12. While the lamp 12 may be any appropriate lamp without departing from the spirit and scope of the present innovation, it is presently expected that the lamp 12 will be an LED (light emitting diode) lamp 12 with an array of LEDs, especially inasmuch as such an LED lamp 12 is known to be able to emit light in an efficient manner and with relatively low power needed to do so. In various embodiments, such an LED lamp 12 is expected to consume 30-80 watts at 12-24 volts DC, although other requirements may also be employed.

As may be appreciated, the lamp 12 may take any appropriate form and may be incorporated into the assembly 10 in any appropriate manner without departing from the spirit and scope of the present innovation. Thus, it may be that the lamp 12 is a fixture set within a cage defined by the pole 11 adjacent the top thereof, or that the lamp 12 is a fixture separate from the pole 11 but attached thereto at the top thereof, or that the lamp 12 is a fixture mounted around pole 11 adjacent the top thereof, or that the lamp 12 is a plurality of fixtures mounted around the pole 11, among other things. Generally, the fixture and lamp 12 may have any appropriate design without departing from the spirit and scope of the present innovation.

The solar panel array 14 as was set forth above acts as a first source of energy to the battery 20 by converting sunlight into electrical energy. As shown in FIGS. 1 and 2, the solar panel array 14 may rest atop the lamp 12, and accordingly may be substantially hidden atop the assembly 10 from below by the pole 11, such lamp 12 and/or adjacent structures. Thus, the solar panel array 14, which may be perceived to be aesthetically ungainly, does not detract from the overall aesthetic appearance of the assembly 10, at least any more than is necessary. The solar panel array 14 may be of any particular manufacture, size, and physical arrangement as may be deemed necessary or advisable. Such solar panel array 14 is generally know, and therefore need not be described herein in any particular detail other than that which is provided. In various embodiments, such solar panel array 14 is expected to supply 10-150 watts at peak sunlight conditions, although other requirements may also be employed.

In order that the solar panel array 14 may be hidden atop the assembly 10, it may be that the array 14 is of a relatively high efficiency and therefore is relatively smaller, perhaps on the order of about 2 square feet in surface area. Such high efficiency in such array 14 is increasingly being demanded and achieved, and therefore is realistic. Also, it may be that the top of the pole 11 and/or the lamp 12 is relatively large so as to hide the array 14. For example, and as seen in FIGS. 1 and 2, it may be that the array 14 is mounted atop a fixture within which the lamp 12 is mounted, where the fixture in turn is mounted to the top of the pole 11, and that the fixture has a relatively broad generally horizontal top surface that acts to shield the array 14 from viewing from below, perhaps on the order of 24 inches in lateral extent.

Note here that such a lamp fixture may include a mount to which the array 14 is affixed, and that the mount may be designed to impart a slight tilt to the mounted array 14, perhaps on the order of 15 degrees or so from horizontal, as is best seen in FIG. 1. As should be appreciated, such a slight tilt may assist to aim the array 14 toward sunlight, and also acts to allow rain water and snow melt water to roll off the surface of the array 14. Alternately, it may be that the array 14 is mounted atop a cage on the pole 11 within which the aforementioned lamp fixture resides, the cage has the aforementioned relatively broad generally horizontal top surface with the mount. Generally, the array 14 may have any appropriate design without departing from the spirit and scope of the present innovation.

Turning now to FIGS. 3-5, the turbine 16 as was set forth above acts as a second source of energy to the battery 20 (FIG. 6) by converting wind energy into rotational energy which drives the generator 18. As was set forth above, the turbine 16 is a vertical-axis wind turbine or the like, which has as its salient features a number of blades 22 (omitted from FIGS. 3a and 3b but shown in FIGS. 4 and 5) which are oriented to longitudinally extend generally vertically and thus generally axially with respect to the axis 24 of the turbine 16. Accordingly, the turbine 16 and the blades 22 thereof prominently extend generally vertically, and not generally horizontally, which is to say that the vertical extent of the turbine 16 is much more prominent than the horizontal extent thereof. As a result, and as was alluded to above, the turbine 16 may be considered to be much more visually aesthetically pleasing than any horizontal-axis wind turbine, and by extension the pole 11 and assembly 10 overall are also considered to be much more visually aesthetically pleasing.

Although the turbine 16 may be most any vertical-axis wind turbine without departing from the spirit and scope of the present innovation, it is to be appreciated that the turbine 16 should be powerful enough to charge the battery 20 sufficiently along with the solar panel array 14. In various embodiments, such turbine 16 is expected to supply 10-300 watts at peak wind conditions, although other requirements may also be employed. Depending on wind and sun conditions at the locale where the assembly 10 is installed, it may be that only the turbine 16 alone is necessary to charge the battery 20 (FIG. 6), or that only the solar panel array 14 alone is necessary to charge the battery 20, or that both are necessary to charge the battery 20.

As shown in at least FIGS. 4 and 5, in at least one embodiment, the turbine 16 is designed to have 5 blades 22, where each blade 22 is oriented to extend longitudinally in a plane generally parallel to the axis 24 of the turbine 16 (i.e., top-to-bottom in both FIGS. 3 and 5). Each blade 22 may be constructed from a lightweight and strong material such as a polycarbonate for durability and to minimize weight. Likewise, each blade 22 may be imparted with an aerodynamic shape judged suitable to efficiently catch wind and thereby rotate the turbine 16. One such aerodynamic shape for each blade 22 is shown in FIG. 5, but it should be appreciated that any appropriate shape may be employed.

As is best seen in FIG. 4, each blade 22 is held at a tangential angle with respect to the axis 24 so as to maximize wind capture and yet minimize excessive shearing torque on such axis 24, thereby achieving optimal energy capture from wind without damage to the turbine 16 at normal wind speeds. Empirically, it has been found that such tangential angle may be about 35-45 degrees, but that such tangential angle may require adjustment based on local conditions, materials employed, etc. Also empirically, it has been found that by vertically angling the blades 22 a small amount, perhaps on the order of 5 degrees, additionally efficiencies may be obtained.

As seen in FIGS. 3 and 4, to hold the blades 22 at the aforementioned tangential angle, the turbine 16 may include a pair of supports 26 that are coaxially mounted on the axis 24 at upper and lower locations thereon. As best seen in FIG. 4, each support 26 includes a number of arms 28 corresponding to the number of blades 22 of the turbine, where each arm 28 has a blade 22 affixed thereto. As also seen, each arm 28 includes a tangential angle surface 30 that abuts the affixed blade 22 and defines the tangential angle thereof. Generally, the turbine 16 may have any appropriate design and construction without departing from the spirit and scope of the present innovation.

In various embodiments, and as best seen in FIG. 1, the turbine 16 is of housed within the pole 11 by being situated within an open cage 32 or other similar structure defined at a midpoint in the vertical extent of the pole 11. Such a midpoint may generally be any point within the vertical extent of the pole 11 that is not at the top or bottom of the pole 11. Thus, the lamp 12 may reside atop the cage 32 in the pole 11 and the turbine 16 in such cage 32. Notably, such a midpoint requires that the pole 11 include structure both above and below. As such, the turbine 16 may be supported within the pole 11 at both upper and lower regions thereof by being coupled to the structure of the pole 11 both above and below, in a manner that will be set forth in more detail below.

Also notably, such an open cage 32 is conceived to vertically extend along the pole 11 and laterally from the pole 11 in a manner so that the cage 32 is generally coaxial with the pole 11 and does not materially extend laterally beyond the lateral extent of the pole 11, at least in a manner that would be perceived to be not visually aesthetically pleasing. That is to say, the cage 32 may indeed extend laterally beyond the general lateral extent of the pole 11, but should only do so in an unobtrusive manner that would be seen to flatter the pole 11 and not ruin the visual lines of the pole 11, such as is shown in FIG. 1. For example, in a case where the pole 11 generally extends laterally about 8 inches (i.e., left-to-right in FIG. 1, and particularly below the cage 32), it may be that the open cage 32 extends laterally about 14 inches and extends vertically about 48 inches (i.e., top-to-bottom in FIG. 1) and is still perceived to be visually aesthetically pleasing, mainly because the lateral extent of the open cage 32 is so much smaller than the vertical extent thereof, yet is not so much greater than the general lateral extent of the pole 11.

The open cage 32 may be defined within the pole 11 in any appropriate manner, as long as the cage 32 is an open-air structure that receives acceptable wind flow and properly supports the turbine 16 therein, and also as long as the cage 32 and the pole 11 with the cage 32 are structurally sound, and further as long as the cage 32 does not materially weaken the pole 11 or otherwise expose the pole 11 to increased risk of damage or harm. Thus, it may be that the cage 32 is defined laterally by a number of peripheral generally vertical ribs or other similar supports, and also a top structure and a bottom structure to which such vertical ribs are attached. As such, the cage 32 is expected to provide sufficient room for the turbine 16 to be situated therein and rotate freely.

Also, the cage 32 is expected to support the turbine 16 therein in an appropriate manner so that the turbine 16 is properly held and is not unduly stressed under normal operating conditions. In particular, and as shown in FIGS. 1 and 3, the cage 32 in various embodiments includes both a first, upper bracket 34 at about the top structure and a second, lower bracket 34 at about the bottom structure, where the upper and lower brackets 34 support the respective upper and lower ends of the axis 24 of the turbine 16 while allowing the axis 24 and turbine 16 to rotate freely. Thus, the turbine 16 is effectively supported within the upper and lower brackets 34 and is not particularly subject to damage from any wind shear force that acts laterally to the axis 24 of the turbine 16. The upper and lower brackets 34 may take any appropriate form, including but not limited to the form seen in FIGS. 3a and 3b, but are each expected to include an appropriate bushing or bearing or the like that receives the respective end of the axis 24 of the turbine 16 and securely holds same while allowing free rotational movement thereof, or are each expected to receive such a bushing or bearing as attached to the respective end of the axis 24 of the turbine 16 (i.e., bushings/bearings 25 shown in FIG. 3a).

As was set forth above, the turbine 16 converts wind energy into rotational energy which drives the generator 18. The generator 18 by extension receives the rotational energy from the turbine 16 and outputs electrical energy, as is known. Such generator 18 may be positioned in the assembly 10 in any appropriate location. That said, it is expected that the generator 18 is positioned immediately below the turbine 16, as is shown in FIGS. 3a and 3b, either within the cage 32 (not shown) or below the cage 32 (shown in FIG. 1) and within an internal void defined by the pole 11. Although the generator 18 may be most any generator without departing from the spirit and scope of the present innovation, it is to be appreciated that the generator 18 should be energy efficient and should be sized to output the electrical energy at a voltage and current suitable for the battery 20.

It is to be appreciated that the turbine 16 may be directly rigidly linked to the generator 18 and therefore may be coaxial and may even share a common axis. However, such a rigid linkage is not optimal inasmuch as any shearing forces experienced by the axis 24 of the turbine 16 would be transmitted to the axis of the generator 18, with the result being that the mounting holding the axis of the generator 18 can become weakened and/or damaged. Accordingly, in various embodiments, the turbine 16 and generator 18 are indirectly linked by an appropriate linkage 35. Such an indirect linkage 35 may be any appropriate linkage such as would be known and/or apparent to the relevant public. For example, such an indirect linkage 35 may be a flexible linkage that transmits rotational forces but not shearing forces.

As should be understood, the battery 20 (FIG. 6) receives the energy generated by the solar panel array 14 and by the turbine 16 and stores same until delivered thereby to the lamp 12. The battery 20 may be any appropriate rechargeable battery as long as such battery 20 is capable of storing a sufficient amount of energy and delivering a sufficient amount of energy to the lamp 12 for a sufficient period of time. For example, the battery 20 may supply energy to the lamp 12 at 12-24 volts DC, and may have enough storage capacity to operate the lamp 12 for 3-5 days. If necessary, the battery 20 may be an array of batteries. Thus, it may be that an array of two batteries has enough capacity to operate the lamp 12 for 6-10 days.

The battery 20 may be positioned within the assembly 10 at any appropriate location, although it is expected that the battery 20 may be located at or adjacent the bottom of the pole 11, perhaps in a void defined therein. Thus, a maintenance worker or the like may easily access the battery 20, perhaps by way of an access panel in the pole 11 (not shown), for purposes of maintaining such battery 20. Within the assembly 10, the battery 20 should be kept from inclement weather and the like so as to remain dry. Thus, the battery 20 is less likely to suffer damage and/or failure based on such inclement weather and the like. Generally, the battery 20 may have any appropriate design without departing from the spirit and scope of the present innovation.

Turning now to FIG. 6, it is seen that both the energy generated by the solar panel array 14 and by the turbine 16 are received by the battery 20 by way of a charge controller 36. The charge controller 36 may be any appropriate controller as long as such controller 36 appropriately regulates the delivery of the energy to the battery 20 in an efficient manner. Thus, the controller 36 ensures that the battery 20 is not overcharged or undercharged, and that the battery is charged at an appropriate voltage, among other things.

As with the battery 20, the charge controller 36 may be positioned within the assembly 10 at any appropriate location, although it is expected that such controller 36 may be located at or adjacent the bottom of the pole 11, perhaps in a void defined therein. Thus, and again, a maintenance worker or the like may easily access the controller 36, perhaps by way of an access panel in the pole 11 (not shown), for purposes of maintaining such controller 36. Generally, the charge controller 36 may have any appropriate design without departing from the spirit and scope of the present innovation.

As known, a typical charge controller supplies energy to charge a battery only until the battery is charged, after which the controller diverts the energy away from the battery and to a dummy load. Accordingly, such a battery is not overcharged and damaged thereby. In the present innovation, though, it may be that no specific dummy load is employed. Instead, in the present innovation, the charge controller 36 may supply energy to charge the battery 20 only until such battery 20 is charged, after which the controller 36 diverts the energy away from the battery 36 and directly to the lamp 12. In such an instance, the lamp 12 acts as the dummy load. As should be understood, the lamp 12 is readily available to be employed as a dummy load, and doing so is not generally harmful to such lamp 12, especially if the lamp 12 is a long-life LED lamp.

Still referring to FIG. 6, it is seen that the energy generated by the turbine 16 and converted by the generator 18 may be rectified if need be prior to being applied to the charge controller 36. In particular, the output of the generator 18 may at times be an alternating current and/or a multi-phase output. In either case, such output should be rectified into an appropriate single-phase direct current (DC) form by an appropriate rectifier 38. The rectifier 38 may be any appropriate rectifier as long as such rectifier 38 appropriately rectifies the input thereof from the generator 18, and delivers energy from the turbine 16 to the charge controller 36 in the form of a DC output.

Also seen in FIG. 6 is a photo sensor 40 which may be employed to activate the lamp 12 only when ambient lighting conditions so warrant. As is known, the photo sensor 40 essentially acts as a relay switch that applies the energy from the battery 20 to the lamp 12 when such ambient lighting conditions fall below a predetermined level. Such photo sensor 40 is generally known and therefore need not be described herein in any detail. Such photo sensor 40 may therefore be any appropriate photo sensor. For example, the photo sensor 40 may be a “Flexcharge Night Watchman 12 volt Dusk to Dawn Photoswitch”, among others. Typically, the photo sensor 40 would be positioned on an exterior portion of the assembly 10 adjacent an upper portion thereof in order to sample ambient lighting conditions adjacent the lamp 12, but not in a location where the activated lamp 12 would affect the photo sensor 40. Thus, it may be that the photo sensor is above and shielded from the lamp 12, perhaps adjacent the solar panel array 14.

Note here that in the case where the charge controller 36 employs no specific dummy load, the controller 36 may divert energy away from the battery 36 and directly to the lamp 12 by electronically positively actuating the photo sensor 40 by way of an appropriate signal thereto (represented by the dotted line in FIG. 6). As should be appreciated, such electronic positive actuation causes the photo sensor 40 to apply the energy that would otherwise be stored in the battery 20 to the lamp 12 regardless of ambient lighting conditions.

In the foregoing description, it can be seen that the present invention comprises a new and useful hybrid outdoor lamp assembly 10 with a solar panel array 14 that is attached atop the pole 11 of the assembly 10 so as to be perceived as being unobtrusive and aesthetic. The assembly 10 employs a vertical-axis wind turbine 16 with a relatively small overall lateral extent so as to also be perceived as being unobtrusive and aesthetic. The vertical-axis wind turbine 16 is mounted at a midpoint of the pole 11 such that the turbine 16 is effectively supported both at the bottom and top thereof and is not vulnerable to wind shear force. Such an assembly 10 has improved overall aesthetics so that the assembly 10 blends harmoniously into the surrounding landscape.

It should be appreciated that changes could be made to the embodiments described above without departing from the inventive concepts thereof. For one example, the location of the generator 18 may be above rather than below the turbine 16, and for another example the solar panel array 14 may be dispensed with if deemed feasible, among other things. It should be understood, therefore, that this invention is not limited to the particular embodiments disclosed, but it is intended to cover modifications within the spirit and scope of the present invention as defined by the appended claims.

I claim:

1. An outdoor light assembly structured as a generally vertically oriented pole, the assembly comprising:
a lamp atop the pole,
a wind turbine attached to a generator, the wind turbine for driving the generator and the generator for outputting electrical energy upon being so driven, and
a battery for storing the electrical energy outputted by the generator and for delivering the stored energy to the lamp,
wherein the wind turbine is housed within a cage defined in the pole at a midpoint in a vertical extent of the pole and generally coaxial with the pole, the midpoint being defined by structures of the pole both above and below such midpoint, the turbine being supported within the cage in the pole at both upper and lower regions thereof by being coupled to the structure of the pole both above and below.

2. The assembly of claim 1, further comprising a solar panel array atop the lamp for outputting electrical energy, the battery for storing the electrical energy outputted by the solar panel array and by the generator and for delivering the stored energy to the lamp.

3. The assembly of claim 1 further comprising a solar panel array atop the lamp for outputting electrical energy, the battery for storing the electrical energy outputted by the solar panel array and by the generator and for delivering the stored energy to the lamp, the solar panel array atop the lamp being substantially hidden from below by the pole and the lamp.

4. The assembly of claim 1, further comprising a solar panel array atop the lamp for outputting electrical energy, the battery for storing the electrical energy outputted by the solar panel array and by the generator and for delivering the stored energy to the lamp, the solar panel array being affixed to a mount built into a top surface of the assembly, the mount imparting a tilt to the affixed solar panel array.

5. The assembly of claim 1, wherein the lamp is a light emitting diode (LED) lamp having an array of LEDs arranged across one or more fixtures.

6. The assembly of claim 1, wherein the lamp is positioned atop the pole above the wind turbine.

7. The assembly of claim 1, wherein the wind turbine is a vertical-axis wind turbine including an axis and a number of blades, each blade being oriented to longitudinally extend generally vertically and thus generally axially with respect to the axis of the turbine, wherein the turbine and the blades thereof prominently extend generally vertically.

8. The assembly of claim 1, wherein the wind turbine is a vertical-axis wind turbine including an axis and a number of blades, each blade being oriented to longitudinally extend generally vertically and thus generally axially with respect to the axis of the turbine, each blade being held at a tangential angle with respect to the axis of about 35-45 degrees, and being vertically angled about 5 degrees.

9. The assembly of claim 1, wherein the wind turbine is a vertical-axis wind turbine including an axis and a number of blades, each blade being oriented to longitudinally extend generally vertically and thus generally axially with respect to the axis of the turbine, the turbine further including a pair of supports coaxially mounted on the axis at upper and lower locations thereon, each support includes a number of anus corresponding to the number of blades of the turbine, each arm having a blade affixed thereto.

10. The assembly of claim 1, wherein the cage is an open-air structure defined laterally by a number of peripheral generally vertical ribs, and includes a top structure and a bottom structure to which the vertical ribs are attached, the cage providing sufficient room for the turbine to be situated therein and rotate freely.

11. The assembly of claim 1 wherein the cage is an open-air structure defined laterally by a number of peripheral generally vertical ribs, and includes a top structure and a bottom structure to which the vertical ribs are attached, the cage including a first, upper bracket at about the top structure and a second, lower bracket at about the bottom structure, the upper and lower brackets supporting respective upper and lower ends of an axis of the turbine while allowing the axis and turbine to rotate freely.

12. The assembly of claim 1, wherein the generator is positioned below the turbine within an internal void defined by the pole, and is indirectly linked to the turbine by a flexible linkage that transmits rotational forces from the turbine but not shearing forces on the turbine.

13. The assembly of claim 1, further comprising a charge controller for regulating delivery of energy from the generator to the battery and a photo sensor for applying the energy from the battery to the lamp when ambient lighting conditions so warrant, the charge controller applying a signal to the photo sensor to cause the photo sensor to apply energy that would otherwise be stored in the battery to the lamp regardless of ambient lighting conditions when the battery is charged, thereby diverting energy away from the battery and preventing overcharging thereof.

14. An outdoor light assembly structured as a generally vertically oriented pole, the assembly comprising
a lamp atop the pole,
a wind turbine attached to a generator, the wind turbine for driving the generator and the generator for outputting electrical energy upon being so driven,
a solar panel array atop the lamp for outputting electrical energy, and
a battery for storing the electrical energy outputted by the solar panel array and by the generator and for delivering the stored energy to the lamp, the solar panel array atop the lamp being substantially hidden from below by the pole and the lamp.

15. The assembly of claim 14, wherein the solar panel array is affixed to a mount built into a top surface of the assembly, the mount imparting a tilt to the affixed solar panel array.

16. The assembly of claim 14, wherein the wind turbine is housed within a cage defined in the pole at a midpoint in a vertical extent of the pole and generally coaxial with the pole, the midpoint being defined by structures of the pole both above and below such midpoint, the turbine being supported within the cage in the pole at both upper and lower regions thereof by being coupled to the structure of the pole both above and below.

17. The assembly of claim 14, wherein the wind turbine is housed within a cage defined in the pole at a midpoint in a vertical extent of the pole and generally coaxial with the pole, the midpoint being defined by structures of the pole both above and below such midpoint, the turbine being supported within the cage in the pole at both upper and lower regions thereof by being coupled to the structure of the pole both above and below, the cage being an open-air structure defined laterally by a number of peripheral generally vertical ribs, and includes a top structure and a bottom structure to which the vertical ribs are attached, the cage providing sufficient room for the turbine to be situated therein and rotate freely.

18. The assembly of claim 14, wherein the lamp is a light emitting diode (LED) lamp having an array of LEDs arranged across one or more fixtures.

19. The assembly of claim 14, wherein the lamp is positioned atop the pole above the wind turbine.

20. The assembly of claim 14, further comprising a charge controller for regulating delivery of energy from the generator to the battery and a photo sensor for applying the energy from the battery to the lamp when ambient lighting conditions so warrant, the charge controller applying a signal to the photo sensor to cause the photo sensor to apply energy that would otherwise be stored in the battery to the lamp regardless of ambient lighting conditions when the battery is charged, thereby diverting energy away from the battery and preventing overcharging thereof.
